(19) United States
(12) Patent Application Publication
(10) Pub. No.: US 2007/0160060 A1
(43) Pub. Date: Jul. 12, 2007

(54) Method of distributed allocation for a medium access control, a method for re-organizing the sequence devices access a medium, a method for avoiding collision, a method of synchronizing devices in a shared medium and a frame structure

(75) Inventors: Francesc Dalmases, Aachen (DE); Joachim Kahlert, Aachen (DE); Thomas Vollmer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,765

(22) PCT Filed: Jan. 25, 2005
(86) PCT No.: PCT/IB05/50285

§ 371 Date: Aug. 7, 2006

(30) Foreign Application Priority Data
Feb. 12, 2004 (EP) 04100524.0

(51) Int. Cl. H04L 12/56

(52) U.S. Cl. 370/395.4

(57) ABSTRACT

A method of distributed medium access control wherein a device that intends to send data first monitors the medium, then pre-occupies a slot and only in case a collision has not occurred starts sending the data. A method for re-organizing the device's sequence for the medium access by using a busy priority signal wherein the device with the highest priority occupies the unused slot and updates it's slot number accordingly. A method for avoiding collision wherein a guard slot is generated just before the beginning of the MFS. A method for synchronizing a device by sensing the medium for a MFS or an EFS. A frame structure with a MFS, an EFS and a transmission portion with both a part for real-time and a part for non real-time transmission.

The invention relates to a network comprising several devices where the transmission operation of one device blocks the other devices that share the network. A mechanism for the medium access control is for example the Carrier Sense Medium Access with Collision Detection (CSMA/CD) in the Ethernet. An advantage of wireless networks is their ease of installation and their flexibility. On the other hand, the demands for the ability to run real-time applications such as Voice over Internet Protocol (VoIP) over these networks has to be answered. A mechanism called Point Coordinator Function (PCF) of the IEEE 802.11 supports real-time traffic.

The invention relates to a method of synchronizing devices that share a transmission medium. In a shared medium all the subscribing stations are connected via a commonly used medium. In the shared medium the data are seen by every node. If the address of a frame matches with the address of a node the data are operated by the subscribing device, if the address does not match the data are rejected.

The invention especially relates to the Quality of Service (QoS) support on unpredictable media. The QoS requirements of real-time traffic concern among others bandwidth, bounded delay and jitter. The network may be based on power line or wireless transmission, e.g. in a Local Area Network (LAN). The transmission mechanism has to be compatible with the CSMA/CD. Carrier Sense means that a station that intends to occupy a time slot for a certain period senses if the channel is busy or not. Only if the medium is free the station may transmit. Multiple Access means that one station immediately after a transmission of a packet re-accesses the medium in order to transmit further data packets.

On such a shared medium real-time transmissions as well as non real-time transmissions occur. Before the transmission starts a station senses the channel and synchronizes itself to the network.

The invention further relates to a method of distributed allocation for a Medium Access Control (MAC). The mechanism for the allocation is based on a priority principle.

Each device serving an isochronous application which requests parameterized guarantees (in terms of latency and bandwidth) has to occupy a time slot. A busy signal and a release symbol margin a time slot.

The length of a medium affects fair, shared access to the medium concerning the delay between frames and the minimum frame length as well as the strength of the electrical signals and noise immunity.

A LAN is a network with the features
bit-serial transmission of information
transmission between independent, but connected devices
shared use of the medium for the transmission by the connected devices
limited geographic extension.

The Ethernet that is defined in IEEE 802.3 and ISO 8802/3 is based on the CSMA/CD.

One object of the invention is to provide a method of distributed allocation for a medium access control (MAC) that enables real-time transmission as well as non real-time transmission on an unpredictable medium wherein a time frame comprises at least one part for real-time transmission and another part for non real-time transmission.

Another object of the invention is to provide a method for re-organizing the sequence for the medium access of at least two devices when an unused slot is detected, the at least two devices constitute a network wherein time slots are used for data transmission.

A further object of the invention is to provide a method for avoiding collision between a non real-time transmission and the beginning of a time frame.

It is also an object of the invention to provide a method of synchronizing a device that intends to occupy a time slot in a shared medium.

A further object of the invention is to provide a frame structure for a time frame or super frame that enables both real-time and non real-time transmission.

As regards the method of distributed allocation for a Medium Access Control the object is solved by a method as defined in claim 1. During the monitoring step the state of the medium is detected by sensing the medium and determining whether the medium has unused slots or not. The slot pre-occupying step serves as a back-off during which time a possibly occurred collision can be detected. And only if a collision is ruled out the send data step is started.

During the monitoring step the device may count the slots that are already occupied. In a fixed system the length of a time frame and of a transmission portion is preset and thus the maximum number of slots.

Counting the slots may be performed by counting busy and release signals that are transmitted before and after a data package is transmitted by another device as the busy and the release signals have a certain format and thus can be recognized.

It is advantageous that the device detects the time used by the slots within the frame as then the remaining time of the time frame can be computed and a transmission would only be started if the remaining time is large enough to ensure that a data package supposed to be sent will completely be transmitted.

Preferably the detection of the time used by the slots is done by counting busy signals that are at the front of a data package.

During the preoccupying step a device with a given slot number counts the previous busy and release signals and subsequently occupies the frame with it's slot number and if a collision occurs after a random time sends a release signal and after a random back-off delay returns to the monitoring step. Thus the preoccupying step serves to avoid in the medium collision by two devices that found the same time slot idle while monitoring.

According to one embodiment during the send data step those devices occupying slots after an unused one compete for the free slot. Once the competition is done the data rate has increased as the formerly free slot is used again.

As regards the method for re-organizing the sequence for the medium access when an unused slot is detected the object is solved by a method with at least two devices that constitute a network wherein time slots are used for data transmission and wherein each of the at least two devices sends a busy priority signal and the device with the highest priority occupies the unused time-slot and updates it's slot number. The priority is inverse to the device's slot number, i.e. the device with the lowest slot number has the highest priority. This is a first-come-first-serve policy.

According to one embodiment the busy priority signal comprises an application priority field and a slot priority field. The application priority field contains an indicator whether it belongs to a real-time application or a non real-time application. The slot priority field may contain the slot number allocated to the device.

Preferably during the non real-time transmission of the medium the access is based on a protocol based on contention such as Carrier Sense Medium Access with Collision Resolution (CSMA/CR).

As regards the method for avoiding collision between a non real-time transmission and the beginning of a time frame the object is solved by transmitting a guard slot that is generated just before the beginning of the time frame. If a collision with the guard slot is detected by a device sending a data package the device stops sending and continues with that data package or the next one later. The use of the guard slot ensures that a possible collision occurs before a new time frame starts with sending a MFS.

As regards the method of synchronizing a device that intends to occupy a time slot in a shared medium the object is solved by independent claims 12 and 13. Claim 12 describes the case that a Master Frame Symbol is expected, claim 13 describes the case that an Echo Frame Symbol is expected.

If a MFS is sensed, the device monitoring the medium becomes a client device, transmits an EFS of first order to inform the master that it participates in the network and adopts the frame time of the master device.

If a MFS is not sensed, the device monitoring the medium itself takes on the role of the master client and transmits a MFS which then can be sensed by other devices monitoring the medium.

An EFS transmitted in the medium has a certain order indicating the hop of the subnet the generating device belongs to. If an EFS is sensed and a preset maximum number of hops is not reached, the device transmits an EFS of the order incremented by one. This EFS is forwarded in the network all through to the master device. The device computes the frame time of the master device as the delay between a MFS and an EFS is fixed and also is the delay between an EFS of a certain order and an EFS of the subsequent order. After having computed the time frame of the master device the new client device adopts it an also participated in the network. By this way even a device that cannot immediately sense a MFS as the device is a hidden node relative to the master device can nevertheless synchronize itself to the time frame.

If an EFS is sensed but it's order has reached a preset maximum number of hops, the device continues with sensing the medium and cannot participate in the currently constituted network.

If an EFS is not sensed, the device takes on the role of a master device, sets the time frame and transmits a MFS.

As regards the frame structure for a time frame or super frame that enables both real-time and non real-time transmission, the object is solved as the frame structure comprises
a Master Frame Symbol MFS,
an Echo Frame Symbol EFS and
a transmission portion with a first part for real-time transmission and a second part for non real-time transmission.

The EFS follows the MFS directly in time with a preset delay. This delay can be used by devices intending to synchronize to the medium for computing the time frame preset by the master device.

Preferably the frame structure's transmission part comprises time slots during which at least the data packages are sent.

The inventive methods may be used in a power line or wireless Local Area Network (LAN) for a transmission with constant bit rate of data belonging to the group of Voice, Voice over IP, Video, ISDN (Integrated Services Digital Network), LBA (Logical Block Addressing), VBA (Visual Basic for Applications), MPEG (Motion Pictures Experts Group).

The inventive method may also be used in a power line or wireless Local Area Network (LAN) for a transmission with variable bit rate of data for applications belonging to the group of Ethernet, Internet, printer or using HTTP (HyperText Transfer Protocol) or FTP (File Transfer Protocol).

The invention will be explained by means of example wherein the drawing shows in

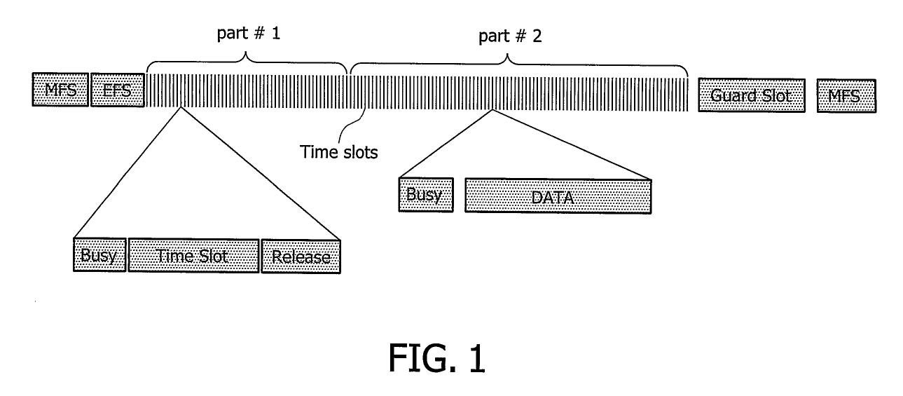

FIG. 1 essential parts of a time frame;

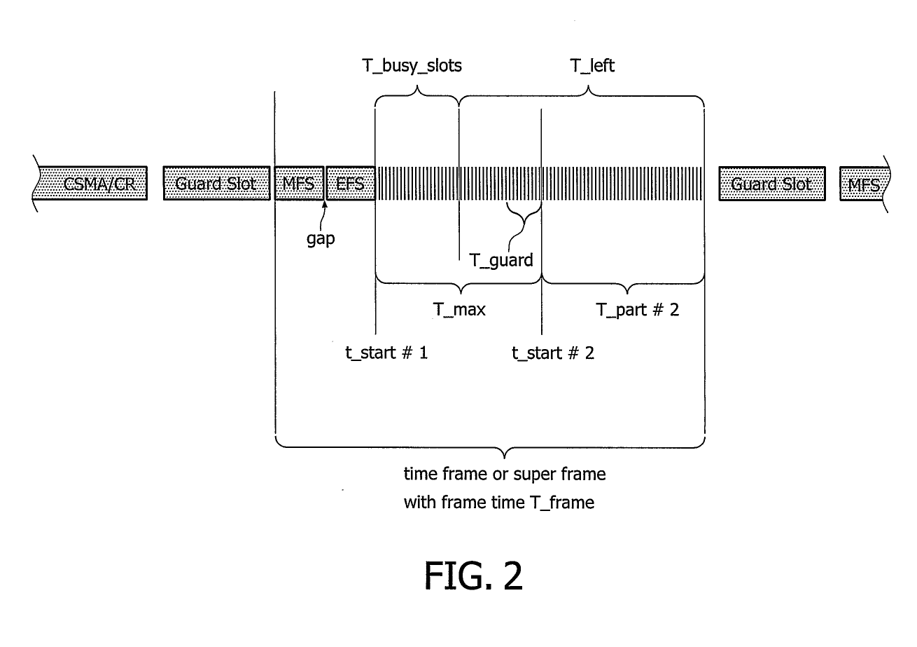

FIG. 2 important time periods and time marks of the time frame of FIG. 1;

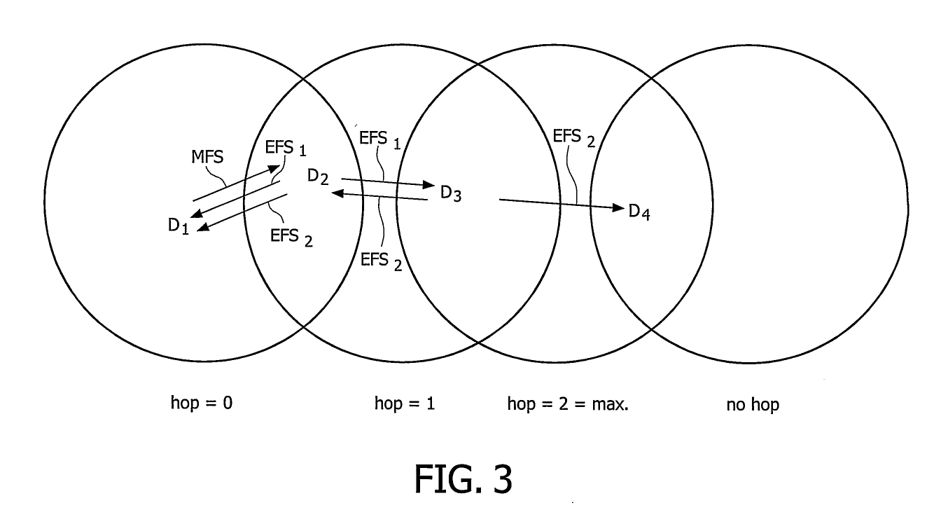

FIG. 3 a network with a certain number of subnets;

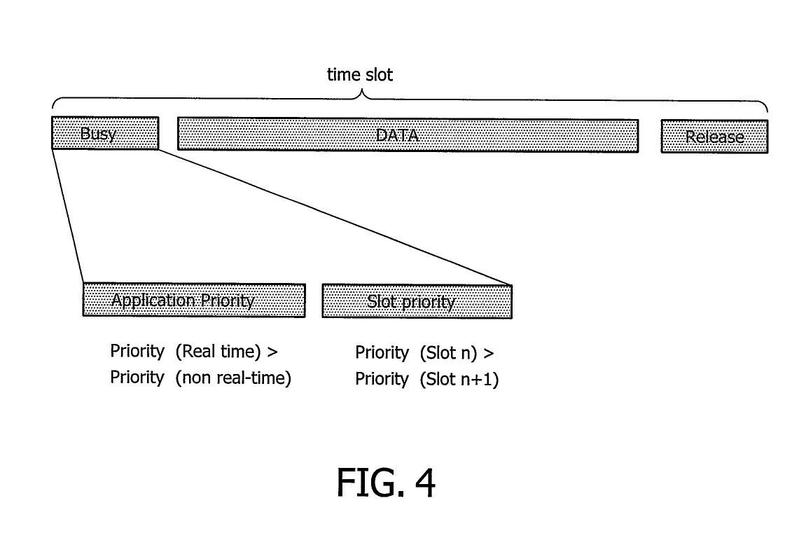

FIG. 4 the structure of a time slot for isochronous application;

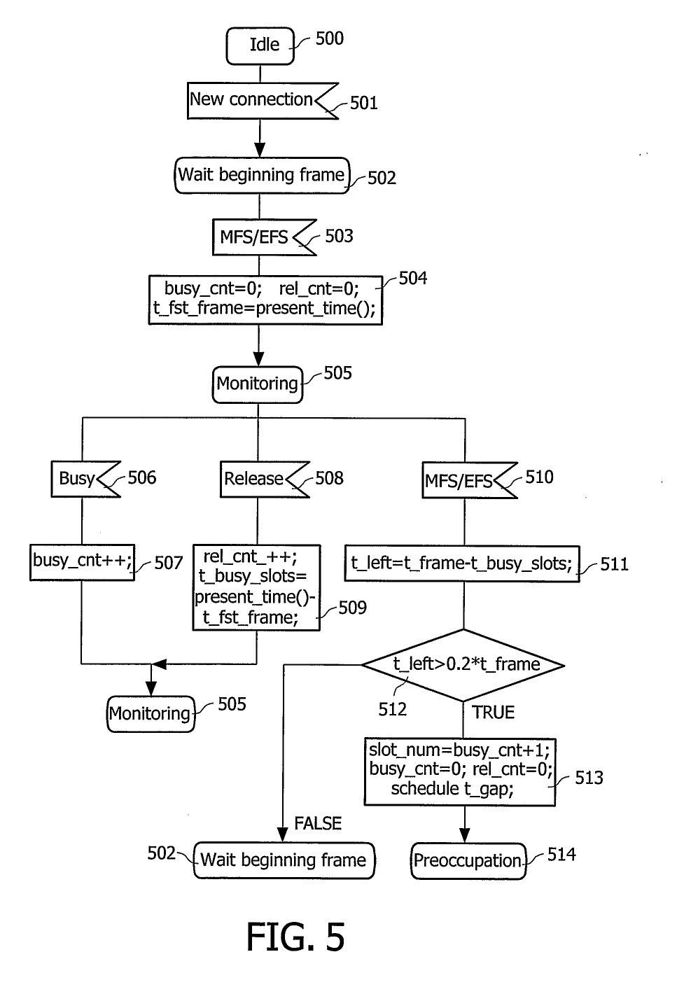

FIG. 5 a flow diagram beginning with an idle state;

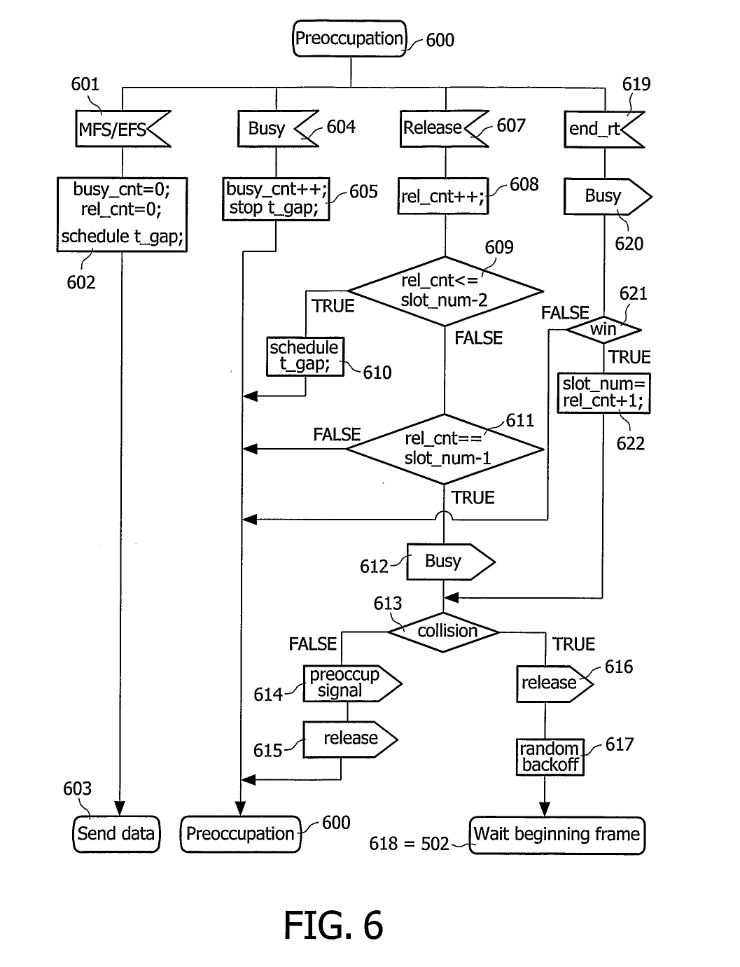

FIG. 6 a flow diagram beginning with a preoccupation state and

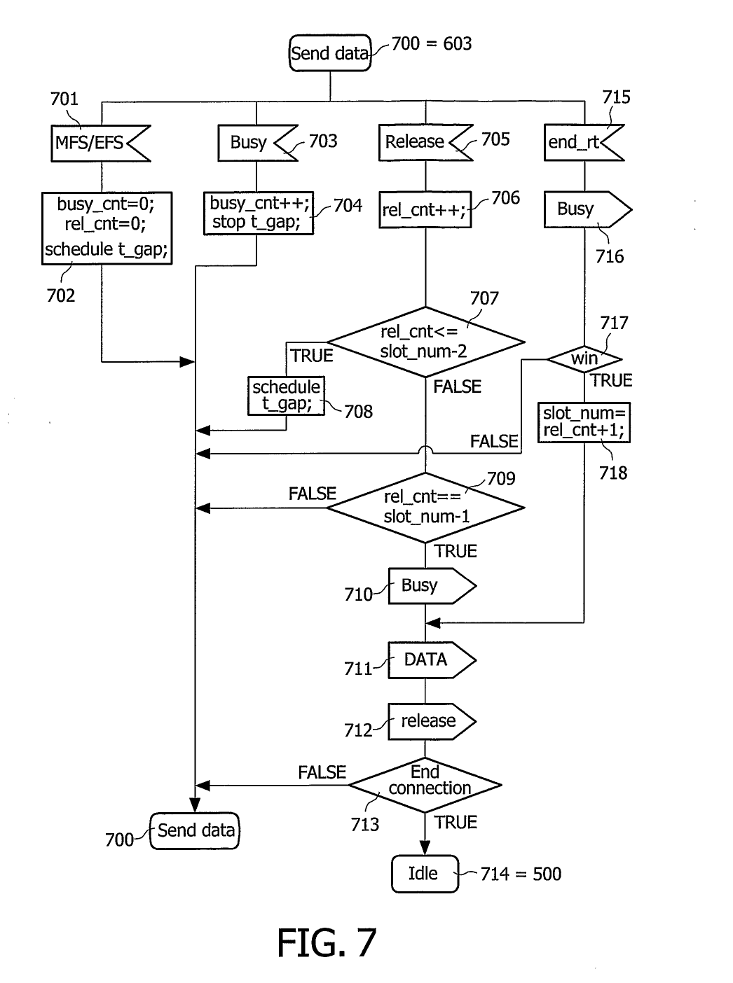

FIG. 7 a flow diagram beginning with a send data state.

FIG. 1 shows the essential parts of a time frame. A time frame or super frame comprises a synchronizing portion with a Master Frame Symbol MFS and an Echo Frame Symbol EFS and a transmission portion with a first part part#1 for real-time transmission and a second part part#2 for non real-time transmission. The first part part#1 is used for isochronous applications wherein the access is guaranteed by slot allocation. A time slot comprises for an isochronous application a busy or busy priority signal at the front a data package which is followed by a release signal. The second part part#2 is used for asynchronous transmission. A time slot comprises for an asynchronous application a busy or busy priority signal at the front a data package. The protocol dedicates the first part part#1 and the second part #2.

FIG. 2 shows important time periods and time marks of the time frame of FIG. 1. The MFS is followed by the EFS directly in time with a delay illustrated by the gap. The gap caused by the delay between the MFS and the EFS is fixed and thus can be used for synchronization by hidden nodes or devices which cannot directly sense the MFS but can compute the system time. A time mark t_start#1 indicates the beginning of the isochronous transmission. A time mark t_start#2 indicates the beginning of the asynchronous transmission. A time period T_max is defined by the difference between the beginning of the asynchronous transmission t_start#2 and the beginning of isochronous transmission t_start#1 and is according to one embodiment of the invention minor to 60% of a frame time period T_frame:
T_max=t_start#2−t_start#1 <60%×T_frame (1)

The period T_frame has a static value whereas the period T_max is variable. The last division of transmission portion's first part part#1 is used as a guard time T_guard. The guard time T_guard is supposed to ensure that a real-time transmission is only started if it can be finished within the maximum time T_max.

In order to guarantee a minimum asynchronous transmission time T_part#2 even under heavy loaded conditions of the media this is defined as:
T_{part#2}>20%×T_{frame} (2)

Just as an example the period of busy slots T_busy_slots is illustrated to show the period T_left remaining for transmission. As the number of devices or subscribers changes in time, the period of busy slots T_busy_slots may vary with each time frame.

FIG. 3 shows a network with a certain number of subnets, in this example three ones. Each circle indicates one subnet. The master's subnet has the index h=0. In this example the maximum number of hops equals 2 (h=2). Preferably each device has a hop counter. A first device “A” senses that the medium is idle and sends an MFS. A second device “B” senses an MFS and in return sends an EFS₁. The response signal EFS₁ indicates an Echo Frame Symbol (EFS) of first order what means that it is an echo immediately activated by the Master Frame Symbol (MFS). The EFS' index is a subnet identifier. The first EFS₁ is sensed by a third device “C”. The third device “C” is a hidden node relative to the first device “A” but synchronizes itself to said first device as the gap between the first EFS and MFS has a fixed time delay. The time delay is added to the forwarded information about the network's respectively the master device's current time frame. Thus even a hidden device can compute the current time of the network and adopt it. In order to inform the first device “A” of the third device “C” being synchronized, the third device sends a response signal of second order, i. e. EFS₂. The EFS₂ signal is forwarded by the second device “B” to the first device “A”. According to one embodiment the second device “B” does not respond to the EFS₂. A hidden node toggles between sensing EFS and echoing EFS. This toggling ensures that the client device is kept synchronized and the EFS is forwarded in the network.

This signal EFS₂ is also sensed by a fourth device “D” but as the maximum number of hops h_max, in this example two hops, is reached the fourth device “D” does not send an Echo Frame Symbol (EFS) and thus does not belong to the currently constituted network which comprises in this example the devices “A”, “B” and “C”.

If a station or device, respectively, that once has been synchronized to the network does not anymore sense a MFS symbol or its echo, respectively, for a limited number of time frames it assumes that all other stations formerly belonging to the network are gone or are in a sleep mode, respectively. This device then takes on the role of the MFS master. If several devices are candidate to become an MFS master, they will compete for this role by collision resolution arbitration in the MFS time slot. That device that occupies the lowest time slot has the highest priority and wins the competition.

FIG. 4 shows the structure of a time slot for isochronous application. The busy or busy priority signal (busy) comprises according to one embodiment two fields. One field, the application priority field, contains information concerning the type of application, i. e. whether it is an isochronous or an asynchronous application. The priority of a real-time application is higher than the priority of a non real-time application. Another field, the slot priority field, contains information concerning the slot number currently dedicated to an application. The priority is inverse to the slot number, i.e. the priority of slot n is higher than the priority of slot n+1. This results in a first-come-first-serve principle.

The steps a real-time application has to pass through are presented in the FIGS. 5 to 7.

FIG. 5 shows a flow diagram beginning with the idle state and comprising the monitoring state. During the first time frame or super frame a device counts the slots that are already occupied by counting the busy and the release signals. The device also measures the frame's time T_busy_slots used by the slots. If there still are resources left for a further slot and for non real-time applications, the device assumes slot number n+1 and goes on to the following step. In this embodiment n is the number of slots already occupied. Otherwise, the device continues with monitoring.

According to a preferred embodiment the monitoring phase takes more than one frame if more than one hop is allowed in the subnet.

Once a slot number is given, isochronous devices use a busy priority signal with a priority in a “slot-number” field inversely proportional to the slot number. That is, the higher the slot number, the lower the priority.

Step 500 is the idle state of a real-time application. Step 501 is the input that a new connection is supposed to be performed. Step 502 is the state of waiting for the beginning of a time frame or super frame. Step 503 is the input of a Master Frame Symbol and/or an Echo Frame Symbol. Following the MFS/EFS input the tasks in step 504 are
set the counter for busy signals to zero [busy_cnt=0];
set the counter for release signals to zero [rel_cnt=0] and
adapt the present time to the frame time [t_fst frame=present_time()]

After having prosecuted the tasks of step 504 the real-time application goes on to the monitoring state of step 505. In case the next input is a busy signal 506, the busy counter is incremented by one [busy_cnt++] and the application goes back to step 505 and continues with the monitoring state.

In case the input finishing the monitoring state is a release signal 508, in the following task step 509
the release counter is incremented by one [rel_cnt++] and
the time period for the busy slots is defined by subtracting the time frame from the present time [T_busy_slots=present_time()−t_fst_frame]

Then the monitoring state 505 is taken up again.

If the step finishing the monitoring state is the input of an MFS/EFS 510, the device intending to perform a real-time application can synchronize itself to the net. In task step 511, the remaining time is computed by subtracting the time of busy slots from the frame time [T_left=T_frame−T_busy_slots].

In condition step 512 it is determined whether the remaining time is larger than 20% of the frame time [T_left>20% T_frame]. If the result of step 512 is
“false”: the loop continues with waiting for the beginning of the frame in step 502;
“true”: in task step 513
   the slot number is adapted to the result of a current number of the busy counter plus 1 [slot_num=busy_cnt+1];
   the busy counter is set to zero [busy_cnt=0];
   the release counter is set to zero [rel_cnt=0] and
   the time interval t_gap is scheduled [schedule t_gap].

The following step 514 is a preoccupation state.

FIG. 6 shows a flow diagram beginning with a preoccupation state and is a continuation of the flow diagram of FIG. 5. The preoccupation has been established to prevent collisions of two or more real-time applications that have monitored the same frame. A device with a given slot number n+1 counts the n previous busy and release signals and occupies immediately it's frame. If a collision occurs it is detected from the echoed busy signal. Then, after a random time, the device sends a release signal and after a random back-off delay return to the first step of monitoring a frame.

The first state 600 is a preoccupation state and equals step 514 of FIG. 5. If the input of step 601 is a MFS/EFS in step 602
the busy counter is set to zero [busy_cnt=0];
the release counter is set to zero [rel_cnt=0] and
the time interval is scheduled (schedule t_gap].

The following next step 603 is the send data state.

If the preoccupation state 600 is finished by the input of a busy signal in step 604, in step 605
the busy counter is incremented [busy_cnt++] and
the time interval is stopped [stop t_gap].

Then the loop goes back to the preoccupation state 600.

If the preoccupation state 600 is finished by input of a release signal in step 607, in step 608 the release counter is incremented [rel_cnt++].

In step 609 the condition whether the release counter is less than or equal to the number of slots minus 2 is determined [rel_cnt<=slot_num−2]. If the result is “true” the time interval is scheduled [schedule t_gap] and the loop goes back to the preoccupation state 600. If the result is “false” the next condition in step 611 is to determine if the release counter equals the number of slot numbers minus 1 [rel_cnt==slot_num−1]. If the result is “false” the loop goes back to the preoccupation state of step 600. If the result is “true” the output is a busy signal in step 612. In the next step 613 the condition whether a collision had occurred is determined. If the result is
“false”: in step 614 a preoccupation signal is sent, afterwards in step 615 a release signal is sent and the loop goes back to preoccupation state 600;
“true”: a release signal is sent in step 616, afterwards in task step 617 a random back-off is performed and then in step 618 the application waits for the beginning of the frame as in step 402.

If the input after the preoccupation step 600 is an end of rt-signal [end_rt] in step 619, afterwards in step 620 an output busy signal is transmitted. In the following step 621 the condition is determined whether the application had won. If the result is
“false”: the loop goes back to the preoccupation step 600;
“true”: in the next step 622 the slot number is adapted to the result of the number of the release counter plus 1 [slot_num=rel_cnt+1].

Then the flow diagram continues with the collision step 613.

FIG. 7 shows a flow diagram beginning with a send data state and is a continuation of the flow diagram of FIG. 6. The device counts the number of busy and release signals to send data in it's corresponding slot. In case a device stops sending data the slot it formerly occupied becomes idle. In order to avoid unused time slots in between all the devices occupying slots after the unused one they compete for the free slot by sending their busy priority signals. A free slot is detected if after a time interval t_gap a busy signal has not been received. The device with the highest priority wins, occupies this slot and updates it's slot number. As the priority is inversely proportional to the slot number the device closest to the free slot wins. The other devices continue sending data in their slots previously assigned. According to one embodiment this mechanism is also applied for the preoccupation.

In step 700 the send data state equals the step 603 of FIG. 6. If the input is an MFS/EFS in step 701 in the following step 702
the busy counter is set to the zero [busy_cnt=0];
the release counter is set to zero [rel_cnt=0] and
the time interval is scheduled [schedule t_gap].

Then the loop goes back to step 700 with the send data state.

If the input of step 703 finishing the send data state is a busy signal in the following step 704
the busy counter is incremented [busy_cnt++] and
the time interval is stopped [stop t_gap].

Then the loop goes back to the step 700 with the send data state.

If the input finishing the send data state is a release signal of step 705 in the following step 706 the release counter is incremented [rel_cnt++]. In the following condition step 707 it is determined whether the release counter is less than or equal to the result of the slot numbers minus 2 [rel_cnt<=slot_num−2]. If the determination's result is
“true”: the time interval is scheduled in step 708 [schedule t_gap];
“false”: in step 709 it is determined whether the release counter equals the result of the slot numbers minus 1 [rel_cnt==slot_num−1].

If the result is
“false”: the loop goes back to step 700 with sending data;
“true”: in the next step 710 a busy signal is output.

In the following step 712 the output is a release signal. In step 713 the condition whether the end of the connection is a reached is determined. If the result is
“false”: the loop goes back to step 700 with the send data state;
“true”: the net becomes idle in the following step 714 which equals the first step 500 of FIG. 5.

If the input finishing the send data state is an end of rt-signal of step 715 in the following step 716 a busy signal is output. The following step 721 is a condition step which determines whether the application has won. If the result is
“false”: the loop goes back to the send data state of step 700;
“true”: the slot number is set equal to the number of the release counter incremented by 1 [slot_num=rel_cnt+1] and the loop continues with the data output of step 711.

The invention may be summarized by a method of distributed medium access control wherein a device that intends to send data first monitors the medium, then pre-occupies a slot and only in case a collision has not occurred starts sending the data; a method for re-organizing the device's sequence for the medium access by using a busy priority signal wherein the device with the highest priority occupies the unused slot and updates it's slot number accordingly; a method for avoiding collision wherein a guard slot is generated just before the beginning of the MFS; a method for synchronizing a device by sensing the medium for a MFS or an EFS and a frame structure with a MFS, an EFS and a transmission portion with both a part for real-time and a part for non real-time transmission.

1. A method of distributed allocation for a Medium Access Control (MAC) that enables real-time transmission as well as non real-time transmission of devices on an unpredictable medium wherein a time frame comprises at least one part (part#1) for real-time transmission and another part (part#2) for non real-time transmission, characterized by the steps of—monitoring the medium;—pre-occupying a slot and —sending data.

2. Method as claimed in claim 1, characterized in that during the monitoring step a device counts the slots that are already occupied.

3. Method as claimed in claim 2, characterized in that the device counts the slots that are already occupied by counting busy and release signals that are transmitted before and after a data package is transmitted by another device.

4. Method according to any one of the preceding claims, characterized in that the device detects the time used by the slots (T_busy_slots) within the frame.

5. Method as claimed in claim 4, characterized in that the detection of the time used by the slots (T_busy_slots) is done by counting busy signals.

6. Method according to any one of the preceding claims, characterized in that during the preoccupation step a device with a given slot number (n+1) counts the n previous busy and release signals and subsequently occupies the frame with it's slot number (n+1) and if a collision occurs after a random time sends a release signal and after a random back-off delay returns to the monitoring step.

7. Method according to any one of the preceding claims, characterized in that during the send data step those devices occupying slots after an unused one compete for the free slot.

8. A method for re-organizing the sequence for the medium access of at least two devices when an unused slot is detected, the at least two devices constitute a network wherein time slots are used for data transmission, characterized in that each of the at least two devices sends a busy priority signal and that the device with the highest priority occupies the unused time-slot and updates it's slot number.

9. Method as claimed in claim 8, characterized in that the busy priority signal comprises an application priority field and a slot priority field.

10. Method according to claim 8 or 9, characterized in that during non real-time transmission (part#2) of the medium the access is based on a contention-based protocol.

11. A method for avoiding collision between a non real-time transmission and the beginning of a time frame, characterized in that a guard slot is generated just before the beginning of the time frame.

12. A method of synchronizing a device that intends to occupy a time slot in a shared medium wherein a time frame comprises several time slots, characterized in that the device senses the medium for a Master Frame Symbol (MFS) transmitted by a master device and—if a Master Frame Symbol (MFS) is sensed, the device becomes a client device, transmits an Echo Frame Symbol of first order and adopts the frame time (t_frame) of the master device;—if a Master Frame Symbol (MFS) is not sensed, the device takes on the role of a master device and transmits a Master Frame Symbol.

13. A method of synchronizing a device that intends to occupy a time slot in a shared medium wherein a time frame comprises several time slots, a master device sets a time frame and at least one client device transmits an Echo Frame Symbol (EFS), characterized in that the device senses the medium for an Echo Frame Symbol (EFS) of i-th order transmitted by a client device and
if an Echo Frame Symbol (EFS) of i-th order is sensed and a preset maximum number of hops (h=max) is not reached, the device transmits an Echo Frame Symbol of (i+1)-th order, computes the frame time (t_frame) of the master and adopts the frame time (t_frame) of the master device;
if an Echo Frame Symbol (EFS) of i-th order is sensed and a preset number of hops (h=max) is reached, the device continues with sensing the medium;
if any Echo Frame Symbol (EFS) is not sensed, the device takes on the role of a master device, sets the time frame and transmits a Master Frame Symbol (MFS).

14. A frame structure for a time frame or super frame that enables both real-time and non real-time transmission, characterized in that the frame structure comprises—a Master Frame Symbol (MFS), —an Echo Frame Symbol (EFS) and—a transmission portion with a first part (part#1) for real-time transmission and a second part (part#2) for non real-time transmission.

15. Frame structure as claimed in claim 14, characterized in that the transmission part comprises time slots.

16. Use of one of the methods as claimed in any of the claims 1 to 13 in a power line or wireless Local Area Network (LAN) for a transmission with constant bit rate of data belonging to the group of Voice, Voice over IP, Video, ISDN, LBA, VBA, MPEG.

17. Use of one of the methods as claimed in any of the claims 1 to 13 in a power line or wireless Local Area Network (LAN) for a transmission with variable bit rate of data for applications belonging to the group of Ethernet, Internet, printer or using HTTP or FTP.
